(19) United States
(12) Patent Application Publication
(10) Pub. No.: US 2020/0307505 A1
(43) Pub. Date: Oct. 1, 2020

(54) Immobilization System for a Vehicle Seat

(71) Applicant: Survivability Solutions LLC, Sterling Heights, MI (US)

(72) Inventor: Sorin Coman, Waterford, MI (US)

(73) Assignee: Survivability Solutions LLC, Sterling Heights, MI (US)

(21) Appl. No.: 16/088,223

(22) PCT Filed: Mar. 24, 2017
(86) PCT No.: PCT/US2017/024030

§ 371 Date: Sep. 25, 2018

(51) Int. Cl. B60R 22/12; B60N 2/879; B60R 22/00

(52) U.S. Cl. CPC B60R 22/12; B60R 22/001; B60N 2/879

(57) ABSTRACT

A vehicle seat includes a seat bottom, a seat back coupled to the seat bottom, and an immobilization system coupled to the seat bottom and the seat back to immobilize an occupant. The immobilization system includes at least one bottom strap kit operatively attached to the seat bottom and at least one back strap kit operatively attached to the seat back at predetermined locations with each of the at least one bottom strap kit and the at least one back strap kit including a strap having a stowed position hidden from view and a deployed position visible to secure an occupant in a seated position against the seat bottom and the seat back.

### CROSS-REFERENCE TO RELATED APPLICATION(S)

The present application claims priority to and all the benefits of U.S. Provisional Patent Application No. 62/313,383, filed on Mar. 25, 2016, which is hereby expressly incorporated herein by reference in its entirety.

### BACKGROUND OF THE INVENTION

### 1. Technical Field

The present invention relates generally to vehicle seats and, more specifically, to an immobilization system for a vehicle seat.

### 2. Description of Related Art

It is known to provide a seat for a vehicle to allow an occupant or passenger to sit in the seat. Typically, the seat includes a seat bottom and a seat back. The seat back may be fixed to the seat bottom or the seat back may pivot relative to the seat bottom. The seat may also include a frame employed to provide structural rigidity and support to the seat and generally to facilitate connection of and between the various components of the seat.

It is also know that vehicles may be involved in a collision or impact and the occupants may be injured. It is further known that additional injuries may occur to injured occupants during the process of removing them from vehicles and transferring them to separate carrying devices such as stretchers for transportation to emergency treatment facilities. In order to extract an occupant from a vehicle after an accident or collision, rescue personnel such as firefighters or medical technicians typically utilize a Kendrick Extraction Device board (a “KED board”) to secure the occupant in an anatomically neutral position in order to prevent injury to the occupant's spine during extraction (not shown, but known in the art). In order to secure the occupant to the KED board before extraction from the vehicle, the occupant must necessarily be repositioned in order to slide the KED board behind the occupant's back. Here, potential injuries sustained during the accident or collision may be exacerbated by certain manipulation of the occupant's body. Moreover, depending on the orientation and condition of the vehicle after the collision, portions of the vehicle may need to be removed or repositioned in order to gain access to the occupant before the KED board can be secured, which can result in undesirable movement of the occupant.

If an injured occupant can be removed from a vehicle without removing the occupant from the seat in which he/she is already seated, then it is possible to avoid movement in an injured spinal column that often leads to spinal cord injuries and permanent paralysis or even death. It is, therefore, desirable for emergency evacuation of injured occupants from vehicles without the need to remove the seated occupants from seats of the vehicle.

### SUMMARY OF THE INVENTION

The present invention provides an immobilization system for a vehicle seat including a plurality of strap kits adapted for attachment to the vehicle seat at predetermined locations on the vehicle seat. Each of the strap kits includes a strap having a stowed position hidden from view and a deployed position visible for securing an occupant in a seated position.

In addition, the present invention provides a vehicle seat including a seat bottom, a seat back coupled to the seat bottom, and an immobilization system coupled to the seat bottom and the seat back to immobilize an occupant. The immobilization system includes at least one bottom strap kit operatively attached to the seat bottom and at least one back strap kit operatively attached to the seat back at predetermined locations with each of the at least one bottom strap kit and the at least one back strap kit including a strap having a stowed position hidden from view and a deployed position visible to secure an occupant in a seated position against the seat bottom and the seat back.

One advantage of the present invention is that a new immobilization system is provided for a vehicle seat that significantly contributes to improved safety by allowing an occupant to be secured in an anatomically neutral position without necessitating excessive manipulation of the occupant during or prior to extraction from a vehicle. Another advantage of the present invention is that the immobilization system may be provided as strap kits for a head, torso, and legs of the occupant. Yet another advantage of the present invention is that the immobilization system may provide grab handles to extract both the vehicle seat and the occupant out of the vehicle together with the occupant immobilized in an anatomically neutral position. Still another advantage of the present invention is that the immobilization system may be provided as a strap kits with clear visual identification to avoid any confusion to an operator. A further advantage of the present invention is that the immobilization system is that all strap kits are 100% recoverable and serviceable for reuse. Yet a further advantage of the present invention is that the immobilization system allows full deployment of auxiliary rescue devices.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a perspective view of a portion of a vehicle having seat assemblies configured for removable attachment to energy absorption modules mounted to the vehicle, with one of the seat assemblies shown detached from the energy absorption module and schematically depicted as having an immobilization system according to the present invention.

FIG. 2 is a perspective view of the seat assembly and energy absorption module of FIG. 1 shown with the seat assembly attached to the energy absorption module, depicting an occupant restrained in the seat assembly with the immobilization system shown in a stowed configuration.

FIG. 3 is a perspective view of the seat assembly and energy absorption module of FIG. 2, with the restrained occupant shown immobilized in the seat assembly by the immobilization system.

FIG. 4 is another perspective view of the seat assembly and energy absorption module of FIG. 3, with the restrained occupant shown immobilized in the seat assembly by the immobilization system.

### DETAILED DESCRIPTION OF THE INVENTION

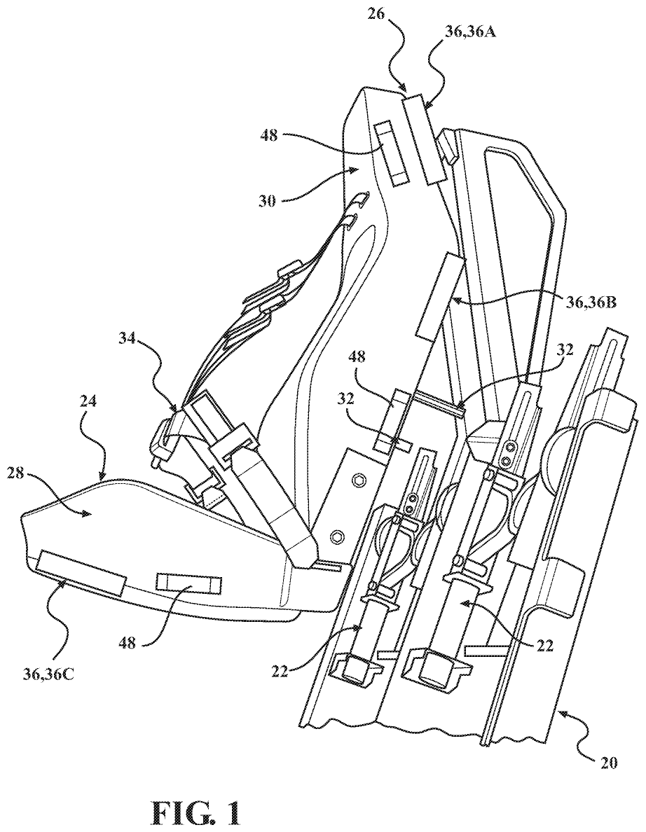

Referring to the drawings, wherein like numerals indicate like parts throughout the several views, a portion of a vehicle is generally indicated at 20 in FIGS. 1, 3, and 4. The vehicle 20 is equipped with a plurality of energy absorption modules, generally indicated at 22, which are configured to removably secure corresponding seat assemblies, generally indicated 24. As explained in greater detail below, the seat assemblies 24 are equipped with an immobilization system, generally indicated at 26 and according to the present invention, which is configured to immobilize a seated occupant for transport with the seat assembly 24.

In the representative embodiment illustrated herein, the vehicle 20 is a military vehicle which is equipped with a plurality of “suspended” or “wall mounted” energy absorption modules 22 configured to absorb forces occurring between the vehicle 20 and an occupant of the secured seat assembly 24 created by relative movement between the occupant and the vehicle 20. For example, the energy absorption module 22 may absorb forces transmitted through the vehicle 20 to the seat assembly 24 so as to minimize force translation from the seat assembly 24 to the occupant. Those having ordinary skill in the art will appreciate that military vehicles become airborne and/or flip sideways, forward, and/or rearward, in which case the energy absorption module 22 not only absorbs the initial force, but also absorbs additional forces resulting from the impact of the vehicle 20 on the ground. Irrespective of the location of the force and the effect of the force on the vehicle 20, the energy absorption module 22 absorbs energy transmitted through the vehicle 20 to the seat assembly 24. The Applicant has described one type of energy absorption module 22 configured to releasably secure seat assemblies 24 in United States Patent Application Publication No. 2016/0297332, based on U.S. Provisional Patent Application No. 62/211,711, the disclosure of both of which are hereby expressly incorporated by reference.

While the vehicle 20 described herein is a military vehicle, those having ordinary skill in the art will appreciate that the vehicle 20 could be of any suitable type, both military and non-military, without departing from the scope of the present invention. By way of non-limiting example, the vehicle 20 could be adapted for civilian, commercial, industrial, or law enforcement use on land, water, or in the air. Moreover, irrespective of the type of vehicle 20, the seat assembly 24 can be used in any suitable location of or within the vehicle 20, (i.e., driver seat, front passenger seat, rear seat, etc.). Similarly, while the seat assembly 24 is depicted throughout the drawings as being removably securable to the energy absorption module 22, those having ordinary skill in the art will appreciate from the subsequent description below that the immobilization system 26 of the present invention could be used in connection with seat assemblies 24 configured to be removably secured to any suitable structure or system utilized in connection with any suitable type of vehicle 20, without departing from the scope of the present invention. By way of non-limiting example, the seat assembly 24 could be configured to be releasably secured to a rigid mount secured directly to the vehicle 20 (not shown, but generally known in the art).

As noted above, the seat assembly 24 is configured to support and restrain a seated occupant, such as military personnel. To that end, as illustrated in FIG. 1, the seat assembly 24 includes a seat portion or seat bottom, generally indicated at 28, and a back portion or seat back, generally indicated at 30. The seat back 30 may be fixed to the seat bottom 28 or the seat back 30 may pivot relative to the seat bottom 28. The seat assembly 24 may also include a frame (not shown, but generally known in the art) employed to provide structural rigidity and support to the seat assembly 24 and generally to facilitate connection of and between the various components of the seat assembly 24 and the immobilization system 26, as described in greater detail below. Typically, the frame is formed of metal. However, those having ordinary skill in the art will appreciate that the frame could be formed or otherwise manufactured from any suitable material sufficient to provide proper support for the occupant. As shown in FIG. 1, the seat assembly 24 includes a pair of coupling rods 32 extending outwardly from the seat back 30 which are configured to be releasably received by the energy absorption module 22 so as to secure the seat assembly 24 to the vehicle 20, as noted above. The coupling rods 32 can be operatively attached to the seat assembly 24, such as to the frame (not shown), in any suitable way without departing from the scope of the present invention. Similarly, the seat assembly 24 could employ any suitable structure or arrangement of components sufficient to facilitate releasable attachment to the vehicle 20, with or without the use of coupling rods 32, without departing from the scope of the present invention.

The seat assembly 24 may also include a seat belt, generally indicated at 34, configured to restrain the occupant. In the representative embodiment illustrated herein, the seat belt 34 is of a “five-point harness” configuration. However, those having ordinary skill in the art will appreciate that the seat belt 34 could be of any type or configuration, such as, for example, a conventional “three-point” harness seat belt, without departing from the scope of the present invention. The seat belt 34 may include a retractor (not described in detail, but commonly known in the art) and may be mounted, anchored, or otherwise attached to portions of the seat assembly 24 and/or the vehicle 20 in any suitable way. Moreover, the seat assembly 24 may further include various additional support and/or structural brackets, braces, plates, washers, bushings, bolts, etc. (not shown) to provide rigidity and support to the components of the seat assembly 24 and/or to facilitate securing the seat assembly 24 to the energy absorption module 22, as noted above.

As noted above, the immobilization system 26 of the present invention is configured to facilitate immobilization of the occupant of the seat assembly 24 for transport, such as after a vehicle 20 collision, accident, and the like. As described in greater detail below, the immobilization system 26 of the present invention overcomes the disadvantages of the KED board by significantly reducing manipulation of the occupant prior to extraction from the vehicle, thereby contributing to reduced risk and improved safety.

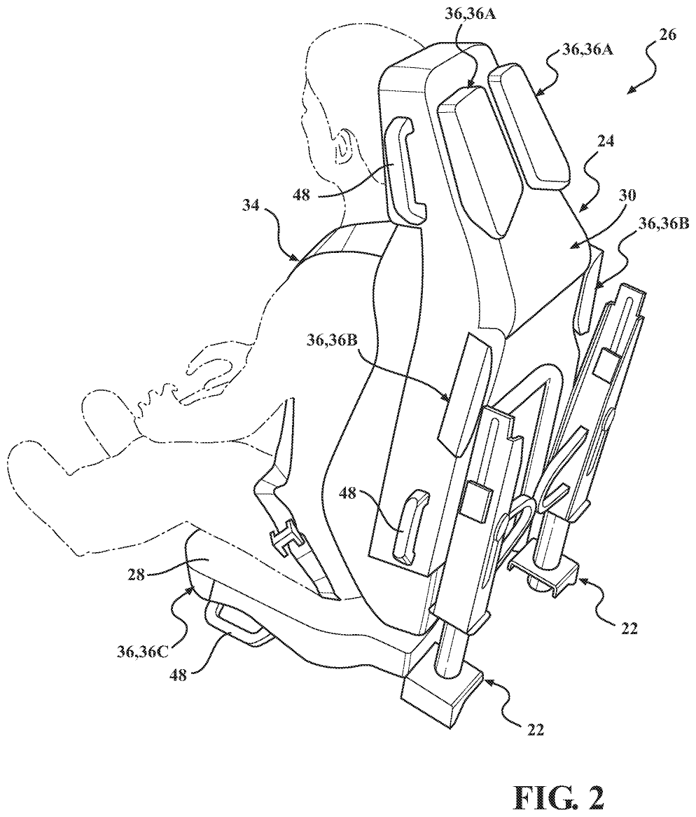

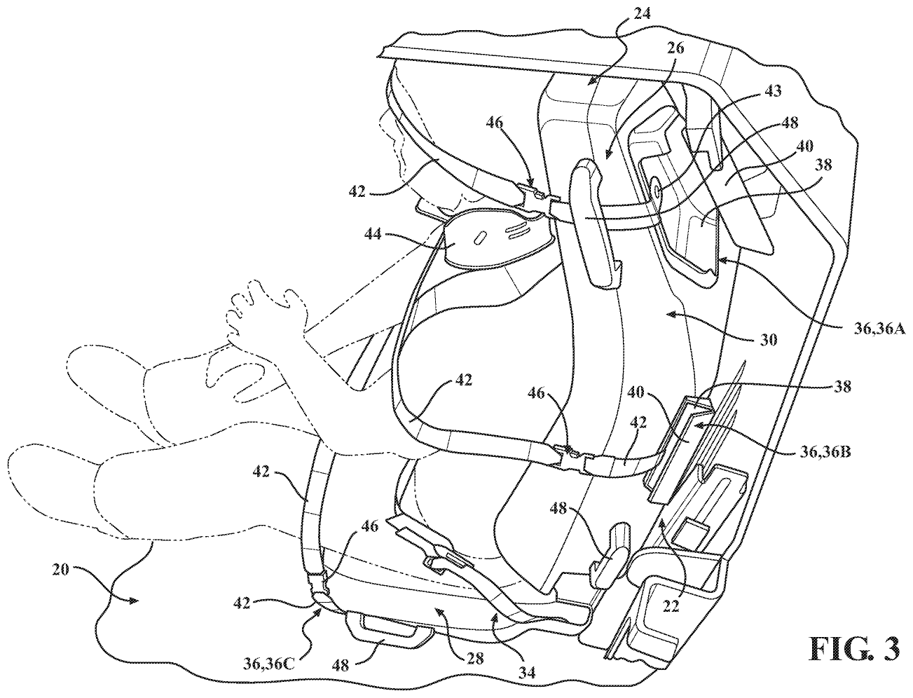

Referring now to FIG. 2, the seat assembly 24 is shown attached to the energy absorption module 22 and with an occupant restrained in the seat assembly 24 via the seat belt 34, and with the immobilization system 26 shown in a stowed configuration, as explained in greater detail below. Here, the immobilization system 26 includes a plurality of strap kits, generally indicated at 36, operatively attached to the seat assembly 24 at predetermined locations along the seat assembly 24. In one embodiment, the immobilization system 26 includes at least one bottom strap kit 36C operatively attached to the seat bottom 28 and at least one back strap kit 36A, 36B operatively attached to the seat back 30 at predetermined locations. Specifically, three pairs of strap kits 36 are provided opposing left and right sides of the occupant's head, torso, and legs: a pair of head strap kits 36A, a pair of torso strap kits 36B, and a pair of leg strap kits 36C. As shown in FIG. 3, each strap kit 36A, 36B, 36C has a container 38, a lid 40, and a strap 42. The containers 38 are configured to accommodate the strap 42 therein, and the lid 40 is coupled to the container 38 and retains the strap 42 in the container 38 until extraction of the occupant is required. Thus, during normal operation of the vehicle 20, each strap 42 is generally concealed within its respective container 38 by the lid 40 when the immobilization system 26 is in the stowed configuration (see FIG. 2).

As illustrated in FIG. 3, the immobilization system 26 includes a fastener 43 such as a rivet or the like to secure or fasten the strap 42 to the seat assembly 24 with the container 38 trapped therebetween. In one embodiment, one end of the strap 42 is secured to the frame of the seat assembly 24 by the fastener 43. The lid 40 has one side pivotally attached to the container 38 by a suitable mechanism such as a hinge (not shown) or the like and an opposed side secured or latched by a suitable mechanism such as a latch or friction fit to the container 38 in a closed position when the strap 42 is in the stowed position within the container 38 and unlatched to the container 38 in an open position when the strap 42 is in the deployed position from the container 38. In some embodiments, the hinge may be a living hinge or a pivoting pin (not shown) connecting the container 38 and the lid 40 together. In some embodiments, the lid 40 and container 38 may be locked or secured together via a friction snap, a strap with a snap, or hoop and loop material (not shown). It should be appreciated that the lid 40 is hinged to the container 38 on one side to allow the opposed side of the lid 40 to open and deploy away from the strap 42 when deployed. It should also be appreciated that the lid 40 may be biased by a suitable mechanism such as a spring (not shown) to open and deploy the lid 40 away from the strap 42 when unlatched or unsecured.

In the representative embodiment illustrated throughout the drawings, the container 38 and lid 40 of the head strap kits 36A are larger than those of the torso strap kits 36B and the leg strap kits 36C so as to further accommodate respective neck brace components 44 (see FIG. 3) which may be used to help stabilize the occupant's neck prior to extraction, as described in greater detail below. Those having ordinary skill in the art will appreciate that the neck brace components 44 can be configured to interlock with each other or otherwise cooperate to stabilize the occupant's neck in any suitable way. Moreover, while the head trap kits 36A accommodate the neck brace components 44 in the representative embodiment illustrated herein, those having ordinary skill in the art will appreciate that any of the strap kits 36 could similarly be configured to secure one or more neck brace components 44.

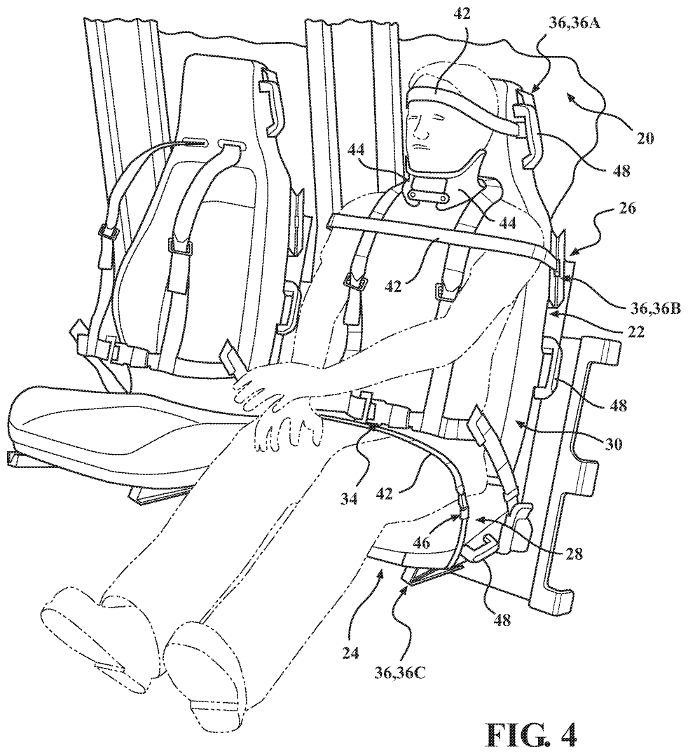

Referring now to FIGS. 3 and 4, the seat assembly 24 is shown with the occupant restrained via the seat belt 34 and also immobilized with the immobilization system 26, which is shown in a deployed configuration. Here, each set of strap kits 36 are arranged laterally on opposing left and right sides of the occupant's body and cooperate to secure the occupant to the seat assembly 24. To that end, the straps 42 of each pair of strap kits 36 connect to each other via a releasable buckle, generally indicated at 46, and the straps 42 can be subsequently tightened to secure the occupant to the seat assembly 24.

As shown throughout the drawings, a total of six strap kits 36 are provided. Specifically, the head strap kits 36A are operatively attached to the seat back 30 and are arranged to secure the occupant's head, the torso strap kits 36B are operatively attached to the seat back 30 and are arranged to secure the occupant's torso, and the leg strap kits 36C are operatively attached to the seat bottom 28 and are arranged to secure the occupant's legs. However, those having ordinary skill in the art will appreciate that the immobilization system 26 could utilize any suitable number of strap kits 36, arranged or configured in any suitable way sufficient to secure the occupant to the seat assembly 24 in an anatomically neutral position, without departing from the scope of the present invention.

In one embodiment, the immobilization system 26 further includes one or more handles 48 operatively attached to the seat assembly 24. The handles 48 are provided to facilitate transport of the seat assembly 24 and the immobilized occupant secured to the seat assembly 24 via the strap kits 36, as described above. To that end, the handles 48 are operatively attached to both the seat bottom 28 and the seat back 30 on left and right sides of the occupant, adjacent to the strap kits 36. As shown throughout the drawings, a total of six handles 48 are provided. However, those having ordinary skill in the art will appreciate that any suitable number of the handles 48, arranged in any suitable way, could be utilized without departing from the scope of the present invention.

As shown best in FIG. 2, the strap kits 36 and the handles 48 are positioned and arranged so as not to impede normal access to the seat assembly 24 or adjacent portions of the vehicle 20. In one embodiment, the handles 48 and/or the containers 38 and lids 40 of the strap kits 36 are colored differently from other portions of the seat assembly 24 so as to draw attention to rescue personnel. By way of non-limiting example, the handles 48 and/or portions of the strap kits 36 could be manufactured from a fluorescent yellow material.

In operation, the seat assembly 24 supports the occupant within the vehicle 20 during normal use and the strap kits 36 of the immobilization system 26 are in the stowed configuration such that the straps 42 and the neck brace components 44 are accommodated in the containers 38 and retained by the lids 40. In the event that the vehicle 20 experiences an accident or collision, rescue personnel can secure the occupant to the seat assembly 24 using the immobilization system 26 and subsequently extract the occupant and seat assembly 24 together from the vehicle 20. To that end, the occupant can be secured to the seat assembly 24 by opening the lids 40 of the strap kits 36 and removing the straps 42. Each pair of straps 42 can be secured together with the buckles 46 and tightened so as to secure the occupant in an anatomically neutral position, such as a seated position (see FIGS. 3 and 4). Here too, rescue personnel can remove the neck brace components 44 from the head strap kit 36A and stabilize the occupant's neck. Next, rescue personnel can release the seat assembly 24 from the energy absorption module 22 and, using the handles 48, extract both the seat assembly 24 and the occupant out of the vehicle 20 together with the occupant immobilized in an anatomically neutral position.

Thus, the immobilization system 26 of the present invention significantly contributes to improved safety by allowing the occupant to be secured in an anatomically neutral position without necessitating excessive manipulation of the occupant during or prior to extraction from the vehicle 20. Moreover, it will be appreciated that the immobilization system 26 of the present invention affords advantages for improved safety in connection with a number of different vehicle types and configurations, and is suitable for use in a number of different applications in a number of different industries.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A vehicle seat comprising:
a seat bottom;
a seat back coupled to said seat bottom; and
an immobilization system coupled to said seat bottom and said seat back to immobilize an occupant, said immobilization system comprising at least one bottom strap kit operatively attached to said seat bottom and at least one back strap kit operatively attached to said seat back at predetermined locations with each of said at least one bottom strap kit and said at least one back strap kit including a strap having a stowed position hidden from view and a deployed position visible to secure an occupant in a seated position against said seat bottom and said seat back.

2. A vehicle seat as set forth in claim 1 wherein said at least one back strap kit includes a pair of head strap kits operatively attached to said seat back for securing a head of the occupant.

3. A vehicle seat as set forth in any one of claims 1 and 2 wherein said at least one back strap kit includes a pair of torso strap kits operatively attached to said seat back for securing a torso of the occupant.

4. A vehicle seat as set forth in any one of claims 1-3 wherein said at least one bottom strap kit includes a pair of leg strap kits operatively attached to said seat bottom for securing legs of the occupant.

5. A vehicle seat as set forth in any one of claims 1-4 wherein each of said at least one bottom strap kit and said at least one back strap kit includes a container, a lid coupled to said container, and said strap.

6. A vehicle seat as set forth in claim 5 wherein said strap is disposed in said container and said lid retains said strap in said container in said stowed position until deployed to said deployed position.

7. A vehicle seat as set forth in any one of claims 5 and 6 wherein said lid has one side pivotally attached to said container and an opposed side latched to said container in a closed position when said strap is in said stowed position and unlatched to said container in an open position when said strap is in said deployed position.

8. A vehicle seat as set forth in any one of claims 5-7 wherein said immobilization system includes a fastener adapted to fasten said strap to the vehicle seat with said container trapped therebetween.

9. A vehicle seat as set forth in any one of claims 1-8 wherein said immobilization system includes a releasable buckle to connect said strap of each pair of said at least one bottom strap kit and said at least one back strap kit to each other.

10. A vehicle seat as set forth in any one of claims 1-9 wherein said immobilization system includes a plurality of handles operatively attached to said seat bottom and said seat back to facilitate transport of said vehicle seat and the immobilized occupant secured to said vehicle seat by said at least one bottom strap kit and said at least one back strap kit.

11. A vehicle seat as set forth in claim 10 wherein said handles are operatively attached to both said seat bottom and said seat back on left and right sides of the occupant and adjacent to said at least one seat strap kit and said at least one back strap kit.

12. A vehicle seat as set forth in any one of claims 1-11 wherein said at least one back strap kit includes a pair of back strap kits on opposing sides of the vehicle seat and laterally aligned with each other.

13. A vehicle seat as set forth in any one of claims 1-12 wherein said at least one bottom strap kit includes a pair of bottom strap kits on opposing sides of the vehicle seat and laterally aligned with each other.

14. An immobilization system for a vehicle seat comprising:
a plurality of strap kits adapted for attachment to the vehicle seat at predetermined locations on the vehicle seat, each of said strap kits including a strap having a stowed position hidden from view and a deployed position visible for securing an occupant in a seated position.

15. An immobilization system as set forth in claim 14 wherein said strap kits include three pairs of strap kits for securing opposing left and right sides of a head, torso, and legs of the occupant in the seated position.

16. An immobilization system as set forth in claim 15 wherein each of said strap kits includes a container, a lid coupled to said container, and said strap.

17. An immobilization system as set forth in any one of claims 15 and 16 wherein said strap is disposed in said container and said lid retains said strap in said container in said stowed position until deployed to said deployed position.

18. An immobilization system as set forth in any one of claims 16 and 17 wherein said container and said lid of said strap kits for the head are larger than said container and said lid of said strap kits for the torso.

19. An immobilization system as set forth in claim 18 including at least one neck brace component disposed within said container and said lid of said strap kits for the head and used to stabilize the neck of the occupant.

20. An immobilization system as set forth in claim 16 wherein at least one of said container and said lid are colored differently from other portions of the vehicle seat.
